(19) United States
(12) Patent Application Publication
(10) Pub. No.: US 2010/0020387 A1
(43) Pub. Date: Jan. 28, 2010

(54) CHIRPED-PULSE QUADRATIC NONLINEARITY-BASED HIGH-ENERGY PULSE COMPRESSOR

(76) Inventors: Frank W. Wise, Ithaca, NY (US); Jeffrey A. Moses, Cambridge, MA (US)

Correspondence Address: JONES, TULLAR & COOPER, P.C., P.O. BOX 2266 EADS STATION, ARLINGTON, VA, 22202, US

(21) Appl. No.: 12/276,560

(22) Filed: Nov. 24, 2008

Related U.S. Application Data
(63) Continuation of application No. PCT/US2007/012305, filed on May 24, 2007.
(60) Provisional application No. 60/802,762, filed on May 24, 2006.

(51) Int. Cl. G02F 1/355; G02F 1/35

(52) U.S. Cl. 359/326

(57) ABSTRACT

A pulse compression technique for compressing femtosecond-duration high-energy pulses first linearly chirps and thus broadens an input pulse before compressing it by nonlinear soliton compression. The technique simultaneously decreases the final compressed pulse duration and improves of the compressed pulse quality. In the preferred embodiment, a linear dispersive delay (12) is employed for chirping the pulse and a single quadratic nonlinear crystal (14) is employed for nonlinear soliton compression of the pulse.

### CROSS REFERENCE TO RELATED APPLICATIONS

This application is a continuation under 35 U.S.C. 120 and 365(c) of International Application No. PCT/US2007/012305, which was filed on May 24, 2007, designates the U.S. and claims the benefit under 35 U.S.C. 119(e) of U.S. Provisional Application No. 60/802,762, filed May 24, 2006, which is hereby incorporated by reference in its entirety.

### GOVERNMENT SPONSORSHIP STATEMENT

This invention was made with government support under National Science Foundation Contract Nos. ECS-0217958 and PHY-0099564. The US government has certain rights in this invention.

### BACKGROUND OF THE INVENTION

1. Field of the Invention

The present invention relates in general to a pulse compressor for compressing femtosecond-duration high-energy pulses in which an input pulse is first linearly chirped and thus broadened before being compressed by nonlinear soliton compression.

2. Description of the Background Art

Pulse compression is an established technique for generating optical pulses shorter than those produced directly by lasers or amplifiers. Most commonly, additional bandwidth is generated by self-phase modulation (SPM) as the pulse propagates nonlinearly in an optical fiber. The negative group-velocity dispersion (GVD) required to compress the pulse is typically provided by gratings, prisms or chirped mirrors. Compressors based on single-mode fibers are limited to nanojoule pulse energies by higher-order nonlinear effects, and ultimately by damage to the fiber. Due to the limitations of laser gain media, high-energy pulse compression techniques have become crucial for the extension of table-top amplified lasers into the petawatt regime and for the production of high-energy single-cycle sources.

Negative (i.e., self-defocusing) phase shifts generated by the cascaded-quadratic (χ⁽²⁾:χ⁽²⁾) nonlinearity are a promising means for achieving this goal. Spectral broadening due to negative nonlinear phase shifts coupled with normal group-velocity dispersion (GVD) has been demonstrated to produce soliton-effect compression of millijoule-energy, 100-fs pulses at a variety of wavelengths and in several nonlinear crystals. The use of a self-defocusing nonlinearity produced in cascaded quadratic interactions allows bulk media to be employed without fear of catastrophic collapse or field distortion due to whole-beam and small-scale self-focusing. Furthermore, lossy diffraction gratings are not needed, so the efficiency of the compressor can exceed 90%.

This technique is disclosed in U.S. Pat. No. 6,650,466 to Liu et al. In a first stage the pulse accumulates a nonlinear phase shift, and the pulse is then compressed by dispersive propagation in a second stage. Positive GVD is needed for compression, and this is provided by a suitably-chosen piece of transparent material. Using this technique, compression of 120 fs pulses from a Ti:sapphire regenerative amplifier to 30 fs with 85% efficiency was demonstrated.

However, the quadratic nonlinearity-based compressor disclosed in the '466 patent works only for suitably long input pulses. For shorter input pulses the effect of group-velocity mismatch (GVM) between the fundamental (FF) and second-harmonic (SH) fields in the compressor distorts the pulse and limits pulse compression. For a given material GVM and FF pulse duration (τ₀), the minimum wavevector-mismatch for which Kerr-like phase shifts can be produced is |Δk|ₘᵢₙ=4π/L_{GVM}=4πGVM/τ₀. For |Δk|>|Δk|ₘᵢₙ the phase shift will mimic that produced by self-phase modulation (SPM), and this range of Δk is referred to as the “stationary” regime of the cascade process. As the pulse duration decreases, larger |Δk| is required to produce undistorted phase shifts. The magnitude of the phase shift decreases with |Δk|, so the GVM determines a minimum pulse duration below which only uselessly-small phase shifts can be generated.

No other suitable techniques for forming femtosecond-duration high-energy pulses have been known previously. For example, pulse compression based on hollow capillaries is limited to millijoule pulse energies, and is rather inefficient. As a result, it is a challenge to produce compressed pulses with peak power that exceeds that of the input pulses.

### SUMMARY OF THE INVENTION

The present invention overcomes the limitations of GVM in cascaded-quadratic compression based pulse compressors by first applying a negative linear chirp to an input pulse before it is subjected to nonlinear quadratic (soliton) compression. The inventors have discovered that the use of chirped input pulses allows one to avoid the limitations of GVM while generating large nonlinear phase shifts. Initial experiments agree with numerical simulations, and compression of 1.2 mJ pulses from 35 fs to 20 fs has been demonstrated in experiments using the invention.

In a preferred embodiment, a pulse is first input to a dispersive delay, which broadens the pulse temporally by applying a negative linear chirp thereto. The chirped pulse is then fed through a quadratic nonlinear crystal (also often referred to as a frequency-doubling crystal), such as BBO or the like, which compresses the chirped pulse using nonlinear soliton compression.

### BRIEF DESCRIPTION OF THE DRAWINGS

The features and advantages of the present invention are set forth in the following detailed description of a preferred embodiment thereof, taken in conjunction with the accompanying drawings, which are briefly described as follows.

FIG. 1 is a schematic illustration of the elements employed in a pulse compressor constructed in accordance with the present invention.

FIG. 2 is a schematic illustration of a preferred embodiment of the present invention which employs a chirped-pulse amplifier (CPA) to generate a chirped pulse that is applied as input to a quadratic nonlinear crystal.

FIGS. 3A-3C are frequency (ω) vs. time (t) graphs depicting of the method of the invention is which an initial negative linear chirp is applied to a pulse in FIG. 3A; the pulse is acted upon by negative SPM in FIG. 3B; and this leads to enhanced spectral broadening as depicted in FIG. 3C.

### DETAILED DESCRIPTION OF THE PREFERRED EMBODIMENT

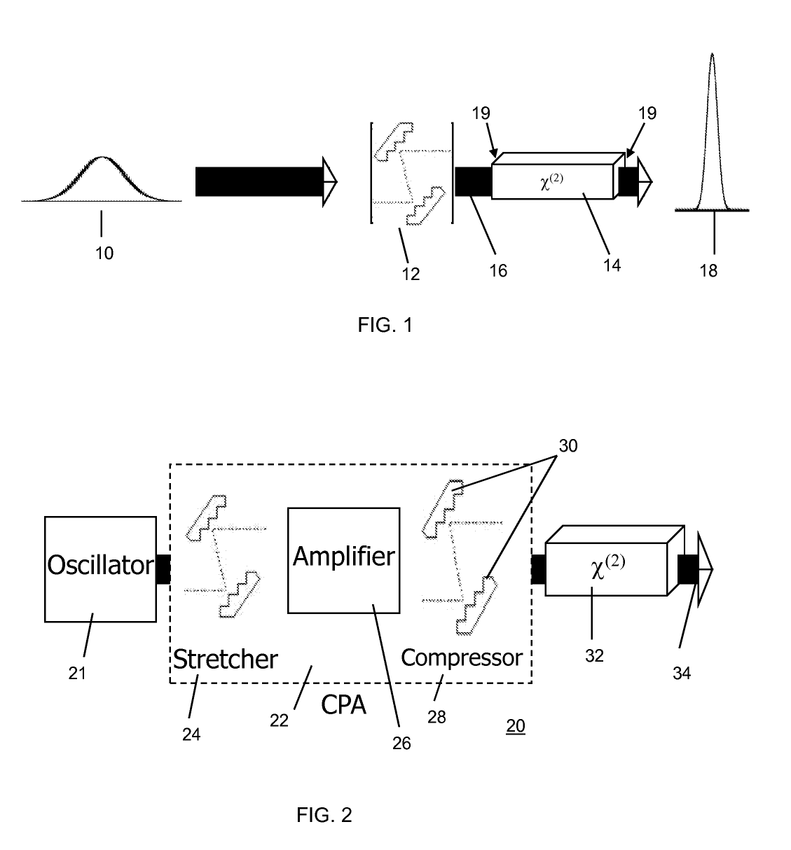

FIG. 1 is a schematic representation of the elements that are employed in any implementation of the present invention. An input pulse 10 to be compressed is first fed through a dispersive delay 12, which is configured to apply a negative linear chirp to the pulse 10. The dispersive delay 12 can be any suitable arrangement of elements, such as pairs of diffraction gratings, prisms, or chirped mirrors, e.g., or it can be a piece of material that has anomalous group-velocity dispersion at the wavelength of interest. A quadratic nonlinear crystal 14 receives as input, the chirped pulse 16 from the dispersive delay 12. The quadratic nonlinear crystal 12 applies nonlinear soliton compression to the chirped pulse 16, thereby generating a compressed output pulse 18. The crystal 12 is preferably formed from any suitable nonlinear material such as barium metaborate (BBO), bismuth borate (BiBO), potassium titanyl phosphate (KTP), lithium iodate (LiIO3), lithium niobate (LiNbO3), periodically-poled lithium niobate (PPLN), potassium niobate (KNbO3) and lithium triborate (LBO). Preferably, the crystal 12 includes antireflection coatings 19 on the facets thereof to improve device performance.

FIG. 2 illustrates a preferred embodiment of the present invention that comprises a pulse compressor 20. The compressor 20 utilizes a conventional oscillator 21 to generate a pulse to be compressed and a chirped-pulse amplifier (CPA) 22 to amplify and apply a negative linear chirp to the oscillator output pulse. As is conventional, the CPA 22 includes a pulse stretcher 24, an amplifier section 26 and a pulse compressor 28. The compressor 28 typically is formed from a pair of diffraction gratings 30 or other dispersive delay that is adjustable, normally to eliminate the positive chirp applied by the pulse stretcher 24. However, for purposes of the present invention, the compressor gratings 30 can be adjusted to apply a negative linear chirp to the amplified pulse. The only other element that needs to be added to the output of the CPA 22 is a quadratic nonlinear crystal 32, which compresses the negatively chirped pulse from the CPA 22 and thereby generates a compressed output pulse 34.

The key to the present invention is the recognition that the stationary region of negative nonlinear phase shifts can be extended significantly by chirping the input pulses. By adding negative linear chirp, longer pulses can be launched, thus increasing L_{GVM} and decreasing |Δk|ₘᵢₙ, but retaining the bandwidth of a transform-limited pulse. If the positive material dispersion is enough to compensate both the initial negative linear chirp and the accumulated negative nonlinear phase shift, the result will be a nearly transform-limited compressed pulse. In addition, the negative linear chirp acts to enhance the soliton-effect compression by increasing the generated bandwidth.

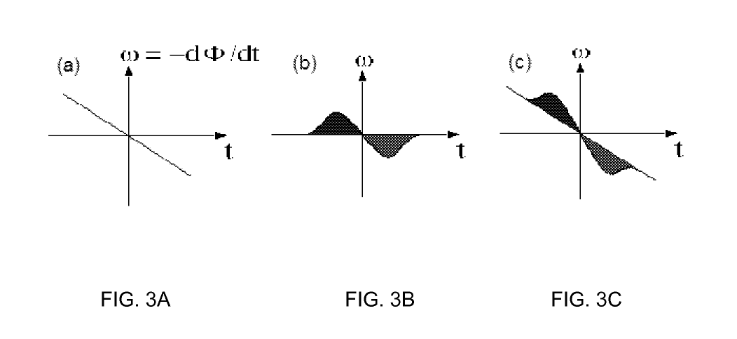

FIGS. 3A-3C illustrate the concept. During the initial negative linear chirp graphically depicted in FIG. 3A and applied to the input pulse by the dispersive delay line 16 in the preferred embodiment, frequencies ω>ω₀ are up-shifted, and frequencies ω<ω₀ are down-shifted. The BBO crystal 12 then acts upon the chirped pulse by negative SPM as depicted in FIG. 3B, which leads to enhanced spectral broadening as depicted in FIG. 3C. The negative chirp results in a larger RMS-bandwidth than the action of SPM on a transform-limited pulse. The benefit of initial negative chirp for cascade compression is thus two-fold.

Numerical simulations confirmed the benefits of chirped input pulses, and guided the conditions of experiments, which were aimed at compression of ˜30 fs pulses from Ti:sapphire amplifiers. In these experiments, the chirped input pulse was obtained by adjustment of the compressor gratings in the Ti:sapphire amplifiers, just as in the CPA 22 of FIG. 2. Thus, no loss of energy was incurred in chirping the input pulses. The intensity and wavevector-mismatch were then adjusted to the desired values.

The coupled wave equations were solved for FF and SH for propagation in a barium metaborate (BBO) crystal at 800 nm. Direct compression of 30 fs pulses is impossible. However, it was discovered that if the pulse was first chirped to 90 fs duration, it would be compressed to 15 fs upon propagation through the BBO crystal. The efficiency is excellent owing to the large phase mismatch, and the peak power of the compressed pulse was 70% greater than that of the original 30 fs transform-limited pulse.

In order to gain familiarity with the 4-dimensional (Δk, intensity, chirp and propagation length) experimental parameter space, initial experiments were performed with a commercial multipass amplifier that generated ˜50 fs pulses. These experiments produced the trends expected theoretically. At that point, compression of 35 fs pulses of up to 2 mJ energy was performed using a multi-stage Ti:sapphire amplifier. The 1/e beam radius was approximately 2 mm. The experimental parameters were explored systematically: pulse propagation was measured in BBO crystals between 8 and 16 mm, at 2 mm intervals. The compressor grating spacing was “misaligned” to produce pulses of 80-120 fs duration and negative chirp. For each combination of crystal length and chirp, the input pulse energy was varied between 0.5 and 2 mJ, and for each combination of the previous three parameters, the wavevector mismatch was varied between 0 and 70π/mm in 6π/mm steps. All observed changes of pulse duration and spectrum closely matched those predicted by numerical simulations.

The best compression results were obtained with 1.2 mJ pulses chirped to 120 fs duration and launched through a 14 mm BBO crystal with Δk˜48π/mm. The intensity was estimated to be in the range of 50-100 GW/cm². A single-shot autocorrelation produced with a 10-μm-thick BBO crystal implied an output pulse duration of 20 fs, assuming a Gaussian temporal shape. The pulse quality was high, and 80% of the incident pulse energy emerged from the BBO crystal at the FF wavelength. The resulting net increase in peak power was ˜30%. Wavefront measurements, using an Imagine Optics HASO wavefront-analyzer, indicated good focusability of the temporally compressed beam, with only λ/35 RMS distortions of the compressed beam relative to the input beam.

The zero-phase Fourier transform of the input spectrum implied a pulse duration of 27 fs, which indicates that the input pulse is ˜30% beyond transform limit. Given the close agreement observed between simulations and experiment, it is expected that compression by a factor of 2 as predicted by simulation can be achieved with pulses that are closer to the transform-limit.

In conclusion, pulse compression by almost a factor of 2 has been obtained in initial experiments with millijoule pulses at 800 nm using the chirped-pulse cascade compression concept of the present invention. Efficiency of ˜80% has been achieved, and this could be increased to 95% by applying anti-reflection coatings to the BBO crystal. With full 2 times compression, a net increase of peak power over 60% should be possible. Scaling of the compression process to higher energies is limited only by the size of available crystals. Commercially-available BBO crystals with 2 cm×2 cm aperture would allow immediate scaling to 20 mJ energies, e.g.

Much better results may be obtained at other wavelengths. For example, at 1064 nm BBO has much lower material GVM and GVD, which allows a larger and less-distorted nonlinear phase shift to accumulate during propagation. Numerical simulations predict compression of 30 fs pulses to 6 fs, with a 200% increase in peak power. Thus the technique may be quite valuable for compression of high-energy sources near 1 μm.

Although the invention has been disclosed in terms of a preferred embodiment and variations thereon, it will be understood that numerous additional modifications and variations could be made thereto without departing from the scope of the invention as defined in the following claims.

1. A method for compressing optical pulses comprising the steps of:
generating an optical pulse;
applying a negative linear chirp to said pulse; and
compressing said pulse using soliton compression in a quadratic nonlinear crystal.

2. The method of claim 1, wherein a dispersive delay is employed for linearly chirping said pulse.

3. The method of claim 2, wherein said dispersive delay is implemented using elements selected form the group comprising pairs of diffraction gratings, prisms, and chirped mirrors, and a piece of material that has anomalous group-velocity dispersion at a wavelength of said optical pulse.

4. The method of claim 3, wherein a crystal formed from a material selected from the group comprising barium metaborate (BBO), bismuth borate (BiBO), potassium titanyl phosphate (KTP), lithium iodate (LiIO3), lithium niobate (LiNbO3), periodically-poled lithium niobate (PPLN), potassium niobate (KNbO3) and lithium triborate (LBO) is employed to compress said pulse.

5. The method of claim 1, wherein said input pulse is selected to have a frequency of 800 nm.

6. The method of claim 1, wherein said input pulse is selected to have a frequency of 1064 nm.

7. A pulse compressor for compressing femtosecond-duration high-energy optical pulses comprising:
a linear dispersive delay for linearly chirping and thus broadening an input pulse; and
a quadratic nonlinear crystal for compressing said linearly chirped input pulse by nonlinear soliton compression.

8. The pulse compressor of claim 7, wherein said quadratic nonlinear crystal is formed of from a material selected from the group comprising barium metaborate (BBO), bismuth borate (BiBO), potassium titanyl phosphate (KTP), lithium iodate (LiIO3), lithium niobate (LiNbO3), periodically-poled lithium niobate (PPLN), potassium niobate (KNbO3) and lithium triborate (LBO).

9. The pulse compressor of claim 7, wherein said crystal includes antireflection coatings disposed on one or more surfaces thereof.

10. The pulse compressor of claim 7, wherein said dispersive delay comprises elements selected from the group comprising pairs of diffraction gratings, prisms, and chirped mirrors, and a piece of material that has anomalous group-velocity dispersion a wavelength of said optical pulses.
